(19) United States
(12) Patent Application Publication
(10) Pub. No.: US 2008/0067774 A1
(43) Pub. Date: Mar. 20, 2008

(54) DOUBLE WISHBONE FRONT SUSPENSION

(75) Inventors: Anthony J. Sanville, Evans, GA (US); Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/532,217

(22) Filed: Sep. 15, 2006

(51) Int. Cl. B60G 3/26; B60G 7/00

(52) U.S. Cl. 280/124.138; 280/124.135; 280/124.145; 280/124.134

(57) ABSTRACT

A suspension system for a golf car includes a vehicle frame having at least first and second longitudinally configured frame elements and first and second channel members, the first channel member connected to the first frame element and the second channel member connected to the second frame element. First and second wishbone assemblies are also provided, the first wishbone assembly coupled to the first channel member and the second wishbone assembly coupled to the second channel member. Each of the first and second wishbone assemblies includes a first wishbone member rotatably connected to a first end of one of the first and second channel members; a second wishbone member rotatably connected to a second end opposite to the first end; and a wheel hub assembly rotatably connected to both the first and second wishbone members.

### FIELD

The present disclosure relates to suspension system devices and methods for configuring suspension systems for a golf car or similar vehicle.

### BACKGROUND

Golf cars commonly have rigid or single axle suspension systems for both the front steerable wheels and the rear driving wheels. A solid axle provides a stiffer ride feel for the occupants and can also result in reduced control of the golf car over rough terrain and when turning at higher speeds. Some golf car designs have therefore used an independent suspension system at least for the front steerable wheels which eliminates the solid axle and separately suspends each front steerable wheel from the frame or structure of the golf car.

Drawbacks of existing independent suspension designs for golf cars include the limited use of single A-arm assemblies used to independently mount the steerable wheels. Single A-arm and support rod assemblies have been used in these applications which are expensive to manufacture and do not deliver true independent suspension motion between the steerable wheels. An improved suspension design is therefore desirable for independent suspensions for golf cars as well as other utility vehicles.

### SUMMARY

According to various embodiments, a suspension system for a golf car includes a vehicle frame and a channel member connected to the frame. First and second wishbone members are rotatably connected to the channel member and operable to rotatably support a wheel hub assembly. A shock absorber assembly freely extends through the first wishbone member and is connected to the second wishbone member.

According to other various embodiments, a suspension system for a golf car includes a vehicle frame having at least first and second longitudinally configured frame elements and first and second channel members, the first channel member connected to the first frame element and the second channel member connected to the second frame element. First and second wishbone assemblies are also provided, the first wishbone assembly coupled to the first channel member and the second wishbone assembly coupled to the second channel member. Each of the first and second wishbone assemblies includes a first wishbone member rotatably connected to a first end of one of the first and second channel members; a second wishbone member rotatably connected to a second end opposite to the first end; and a wheel hub assembly rotatably connected to both the first and second wishbone members.

According to other various embodiments, a golf car includes a frame and a front suspension system adjustably connected to the frame having a first side and a second side operable to rotatably support a first steerable wheel from the first side and a second steerable wheel from the second side. A first double wishbone assembly is connected to the first side of the front suspension system. A second double wishbone assembly is connected to the second side of the front suspension system.

In still further embodiments, a method for using a double wishbone suspension system in a golf car, the golf car having a frame, the suspension system including an upper and lower wishbone member connected to an adjustably located structural member, a shock absorber and a wheel hub assembly includes rotatably coupling both the upper and lower wishbone members to the structural member. The method further includes connecting the shock absorber to both the lower wishbone member and an arm extending from the structural member. The method still further includes rotatably connecting distal ends of both the upper and lower wishbone members to the wheel hub assembly.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having a double wishbone front suspension according to various embodiments of the present disclosure;

FIG. 2 is a bottom plan view of the golf car of FIG. 1;

FIG. 3 is a front elevational view of the golf car of FIG. 1;

FIG. 4 is a perspective view of a golf car frame and steering assembly together with the double wishbone front suspension of the present disclosure;

FIG. 5 is a perspective view of the double wishbone front suspension of the present disclosure;

FIG. 6 is a front elevational view of a U-shaped channel of the present disclosure;

FIG. 7 is a side elevational view of the U-shaped channel of FIG. 6;

FIG. 8 is a top plan view of the U-shaped channel of FIG. 6;

FIG. 9 is a top plan view of a first wishbone member of the present disclosure;

FIG. 10 is a side elevational view of the first wishbone member of FIG. 9;

FIG. 11 is a top plan view of a second wishbone member of the present disclosure; and

FIG. 12 is a side elevational view of the second wishbone member of FIG. 11.

### DESCRIPTION OF VARIOUS EMBODIMENTS

The following description is merely exemplary in nature and is in no way intended to limit the present disclosure, their application, or uses. Throughout this specification, like reference numerals will be used to refer to like elements. As referred to herein, the term “golf car” is synonymously used to describe application of the present disclosure to golf cars as well as sport utility vehicles such as modified golf cars, used for example as food and/or beverage cars, golf cars adapted for use as hunting/sporting clays vehicles, golf course maintenance vehicles, and the like.

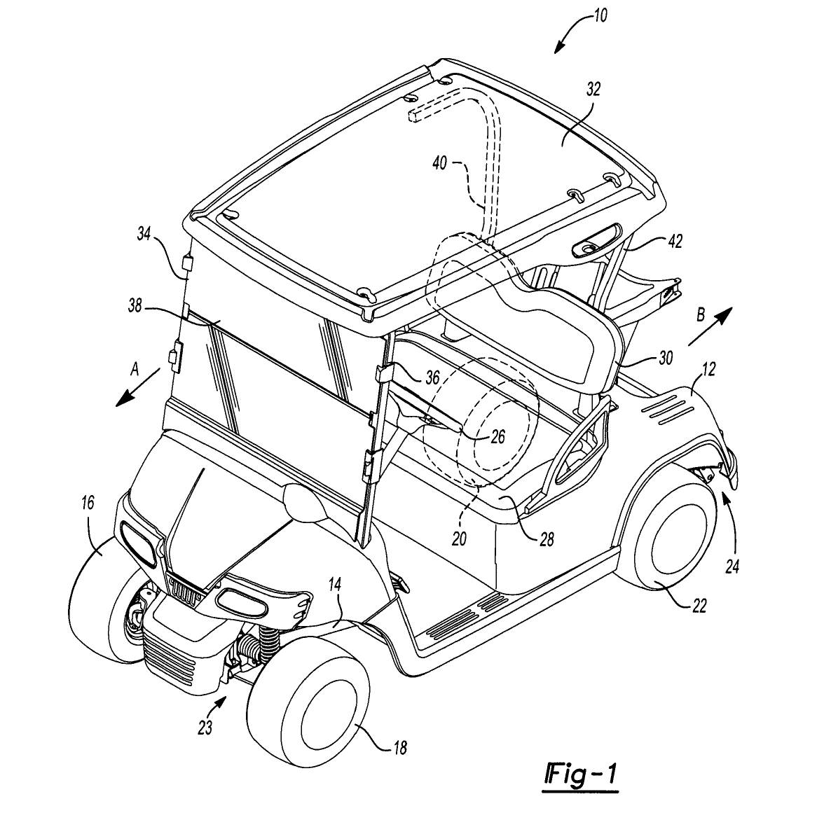

Referring generally to FIG. 1, a golf car 10 can include a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A double wishbone front suspension system 23 can also be provided which is adapted for supporting each of the first and second steerable wheels 16, 18. A rear suspension system 24 can also be provided which is adapted for supporting each of the first and second driven wheels 20, 22. A steering mechanism 26 which commonly includes a steering wheel and a support post assembly is also included to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second support members 34, 36. A windscreen or windshield 38 can also be provided which is also supported by each of first and second support members 34, 36. A rear section of roof 32 can be supported by each of a first and a second rear support element 40, 42. Other items provided with golf car 10 include golf bag support equipment, accessory racks or bins, headlights, side rails, fenders, and the like.

Golf car 10 is commonly propelled by a power unit such as an engine or battery/motor system which can be positioned below and/or behind bench seat 28. Golf car 10 is capable of motion in either of a forward direction “A” or a rearward direction “B”. Each of first and second driven wheels 20, 22 can be commonly supported to frame 14 using multiple designs for rear suspension system 24. The present disclosure is therefore not limited by the design of rear suspension system 24.

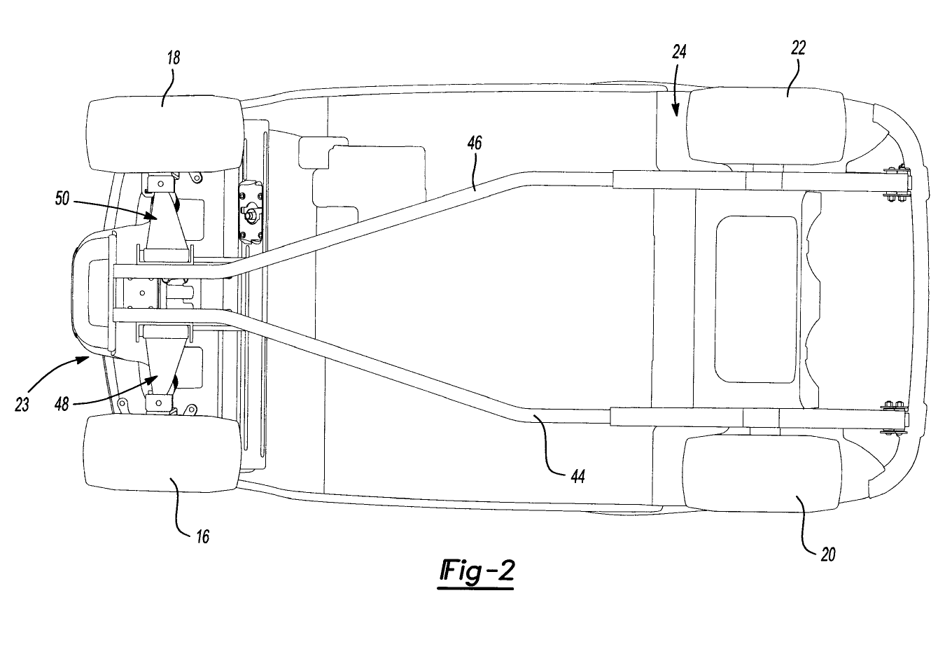

As best seen in reference to FIG. 2, frame 14 can further include a substantially longitudinally arranged first frame member 44 and a mirror image arranged second frame member 46. First and second frame members 44, 46 can be hollow, tubular shaped members created of a metal such as a steel material or similar structural material and formed by welding, extruding, hydroforming, or similar processes. Front suspension assembly 23 can include each of a first double wishbone subassembly 48 supporting first steerable wheel 16 and a second double wishbone subassembly 50 supporting second steerable wheel 18.

Referring now generally to FIG. 3, golf car 10 includes front suspension system 23 adjustably connected to frame 14. First double wishbone subassembly 48 includes a first wishbone member 54 rotatably fastened to an upper or first end of a first U-shaped bracket or channel 56, and a second wishbone member 52 is rotatably fastened to a lower or second end of first U-shaped channel member 56. Both first and second wishbone members 54, 52 are rotatably supported at outboard facing ends to a substantially U-shaped first flange 58. A first shock absorber assembly 60 freely extends through the first wishbone member 54 and is connected between second wishbone member 52 and a first support assembly 62. The configuration of second double wishbone subassembly 50 is substantially a mirror image of first double wishbone subassembly 48. Second double wishbone subassembly 50 includes a third wishbone member 66 rotatably fastened to an upper or first end of a second U-shaped bracket or channel 68, and a fourth wishbone member 64 rotatably fastened to a lower or second end of second U-shaped channel member 68. Both third and fourth wishbone members 66, 64 are rotatably supported at outboard ends to a substantially U-shaped second flange 70. A second shock absorber assembly 72 freely extends through the third wishbone member 66 and is connected between fourth wishbone member 64 and a second support assembly 74.

A plane 71 defined through individual ones of the rotational axes of first and second steerable wheels 16, 18 is maintained substantially parallel with a ground surface 73 as each of first and second double wishbone assemblies 48, 50 deflect and first or second flange 58, 70 deflects about an arc of rotation 75. This maximizes a surface area of first and second steerable wheels 16, 18 in contact with ground surface 73.

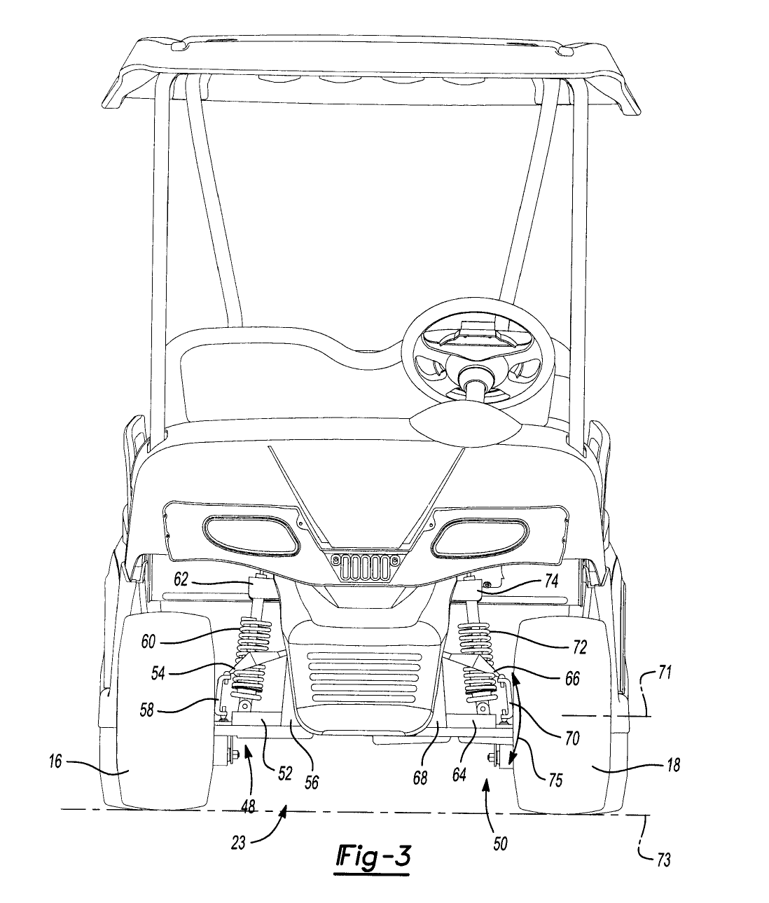

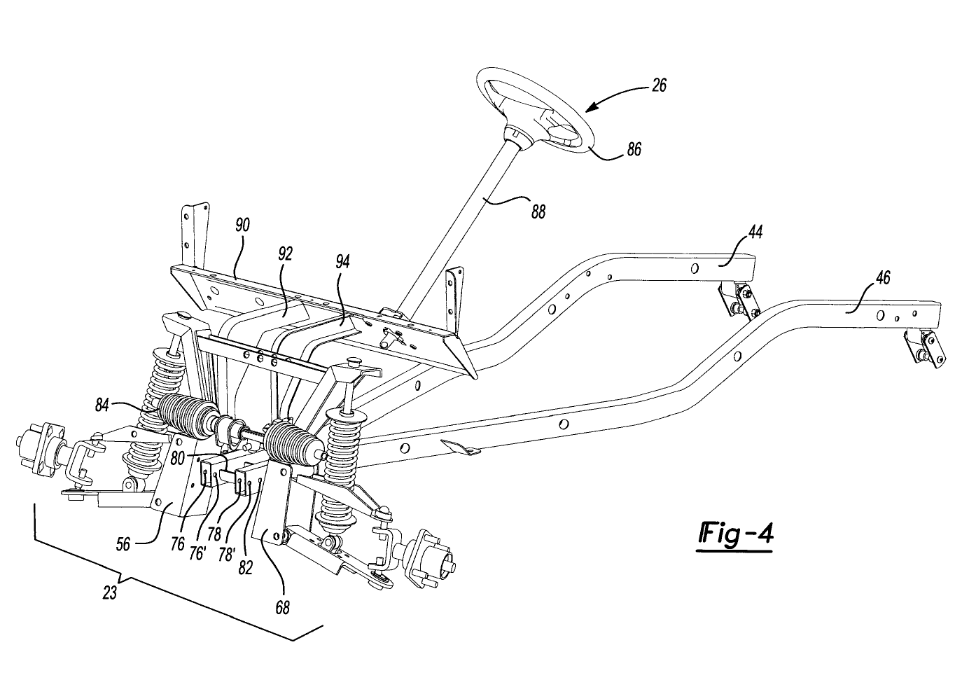

Referring now generally to FIG. 4, front suspension system 23 is shown in an exemplary installed position with respect to first and second frame members 44, 46. A first forward pair of co-axially aligned through bores 76, 76′ created through first frame member 44 receive a fastener (not shown) which is engaged with first U-shaped channel member 56. Similarly, a first forward pair of co-axially aligned through bores 78, 78′ created through second frame member 46 are co-axially aligned with through bores 76, 76′, and receive a fastener (not shown) which is engaged with second U-shaped channel member 68. Second rearward pairs of through bores 80, 80′ and 82, 82′ are similarly created in first and second frame members 44, 46 which each receive a fastener (not shown) to further connect first frame member 44 to first U-shaped channel member 56 or to connect second frame member 46 to second U-shaped channel member 68.

Front suspension system 23 can receive steering input from a rack and pinion assembly 84 which receives rotational input from a steering wheel 86 and steering column 88 of steering mechanism 26. Steering column 88 can be rotatably mounted to a support structure 90 which can be connected to each of first and second frame members 44, 46 by a first and second connecting member 92, 94 respectively.

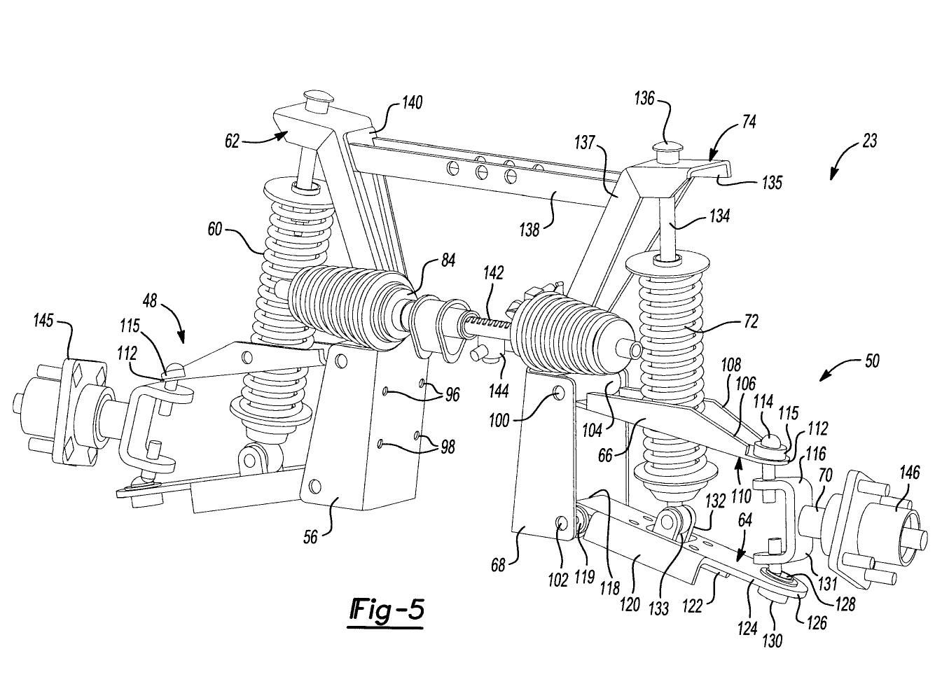

Referring now generally to FIG. 5, second U-shaped channel member 68 is a mirror image configuration of first U-shaped channel member 56. Each of first and second U-shaped channel members 56, 68 include a first pair of apertures 96 and a second pair of apertures 98 defining a predetermined pattern of apertures. Apertures 96 are aligned with corresponding ones of through bores 76, 76′ and 80, 80′ of first frame member 44, or with through bores 78, 78′ and 82, 82′ of second frame member 46 to establish a first height of front suspension system 23. To adjust to a second height of front suspension system 23, second apertures 98 are used.

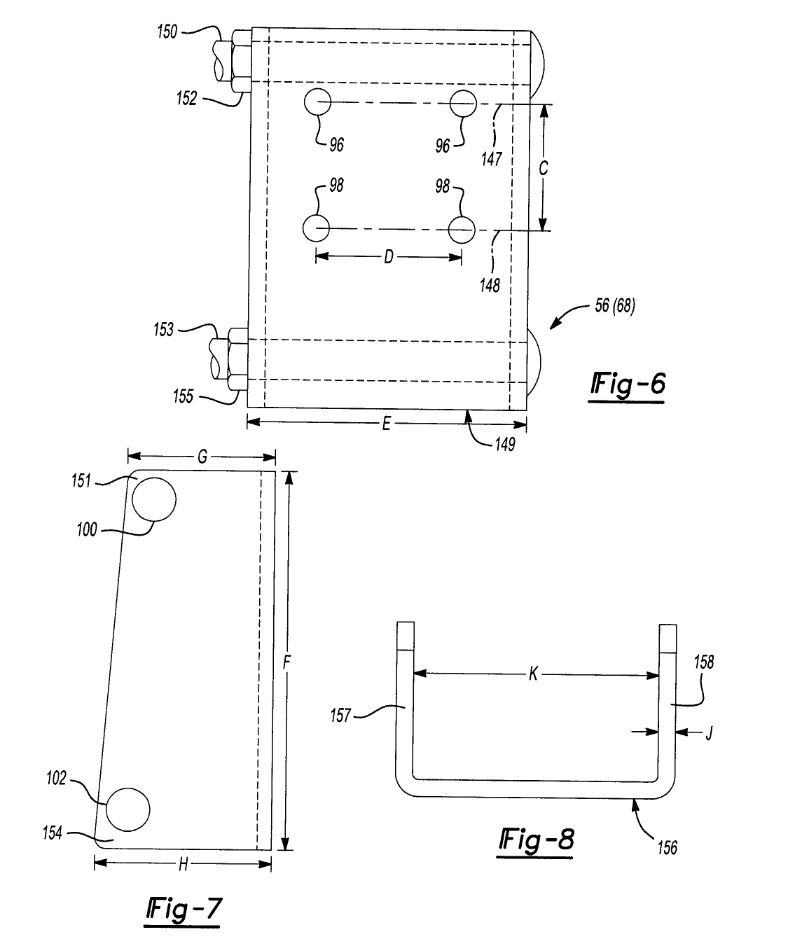

First and second double wishbone subassemblies 48, 50 are substantially mirror image arrangements, therefore the following discussion of second double wishbone subassembly 50 applies equally to corresponding components of first double wishbone subassembly 48. Each of first and second U-shaped channel members 56, 68 include opposed walls having a co-axially aligned pair of first mount apertures 100 and a pair of second mount apertures 102. First mount apertures 100 receive a fastener such as a bolt or pin described in reference to FIGS. 6-8, which rotatably mounts a rolled end 104 of third wishbone member 66. Third wishbone member 66 (as well as first wishbone member 54) can include opposed first and second stiffening walls 106, 108 which extend substantially transversely from a substantially planar support plate 110. An extension plate portion 112 of support plate 110 extends beyond first and second stiffening walls 106, 108 to receive a ball joint assembly 114 which is received in a bushing 115. Ball joint assembly 114 is connected to a first end 116 of second flange 70.

Second mount apertures 102 of first and second U-shaped channel members 56, 68 receive a fastener such as a bolt or pin described in reference to FIGS. 6-8, which rotatably mounts a rolled end 118 of fourth wishbone member 64. Fourth wishbone member 64 (as well as second wishbone member 52) includes opposed first and second stiffening walls 120, 122 which extend substantially transversely from a substantially planar support plate 124. An extension plate portion 126 of support plate 124 extends beyond first and second stiffening walls 120, 122 to receive a second ball joint assembly 128 which is received in a bushing 130. Second ball joint assembly 128 is connected to a second end 131 of second flange 70.

A polymeric or resilient material washer 119 can be positioned at opposite ends of both rolled ends 104 and 118. Washers 119 reduce rotational friction at rolled ends 104 and 118 at the connections with first and second U-shaped channel members 56, 68.

A clevis 132 is fixedly connected to support plate 124 for example by welding or fastening. Clevis 132 receives a connecting sleeve 133 defining a first connecting end of second shock absorber assembly 72 using a fastener or pin (not shown). An oppositely extending piston rod 134 defining a second connecting end of second shock absorber assembly 72 is connected to a bracket end 135 of second support assembly 74 using a fastener 136. Second support assembly 74 also includes a main arm 137 fixedly connected to second U-shaped channel member 68 for example by welding. A cross member 138 having a connection plate 140 positioned at opposed ends is fixedly connected to the main arm 137 of both first and second support assemblies 62, 74 by welding or fastening at the connection plates 140. Rack and pinion assembly 84 further includes a rack 142 engaged by a pinion gear 144. Rack and pinion assembly 84 is connected to both first and second flanges 58, 70 to rotate each of a first and second wheel hub 145, 146.

Referring now to FIGS. 6 through 8, first U-shaped channel member 56 is substantially identical to second U-shaped channel member 68, therefore the following discussion also applies to second U-shaped channel member 68. Apertures 96 are co-axially aligned on a first axis 147, and apertures 98 are co-axially aligned on a second axis 148. First and second axes 147, 148 are parallel with each other and substantially parallel with a surface 149. As previously described, fasteners can be inserted through apertures 96 or 98 to connect first U-shaped channel member 56 to frame 14. First apertures 96 on first axis 147 define a first frame connecting position for front suspension system 23. Second apertures 98 on second axis 148 define a second frame connecting position for front suspension system 23. The difference between the first and second frame connecting positions operates to define an adjustable height “C” of front suspension system 23. A first pin 150 can rotatably connect the first wishbone member 54 through first mount apertures 100 to first channel member 56 proximate a first end 151 of first channel member 56. A nut 152 can be used to fasten first pin 150. Similarly, a second pin 153 can rotatably connect the second wishbone member 52 through second mount apertures 102 to first channel member 56 proximate a second end 154 of first channel member 56. A nut 155 can be used to fasten second pin 153. Apertures 96 and 98 are each created through a plate portion 156.

The substantially circular-formed rolled end 104 of each of the first and third wishbone members 54, 66 receive one of the first pins 150. First and second pins 150, 153 are each inserted through one of the first or second mount apertures 100 or 102 which are created in each of a first and second opposed side 157, 158. The polymeric, resilient material washers 119 positioned at each end of both rolled ends 104 and 118 have a through aperture which receives individual ones of the first or second pins 150, 153 to reduce rotational friction at rolled ends 104 and 118.

In several embodiments, individual apertures 96 and individual apertures 98 are separated by a distance “D” which corresponds to an equivalent spacing between through bores 76, 80 of first frame member 44, or between through bores 78, 82 of second frame member 46. In several embodiments, first U-shaped channel member 56 has a plate portion 156 having a width “E”, a total U-channel height “F”, and opposed sides 157, 158 have a depth varying from a depth “G” proximate first end 151 to a depth “H” proximate second end 154. A wall thickness “J” can be substantially constant throughout first U-shaped channel member 56. A spacing “K” between opposed sides 157, 158 can be varied to accommodate the use of washers 119.

Referring now in general to FIGS. 9 and 10, each of the first and third wishbone members 54, 66 are substantially identical, therefore the following discussion of first wishbone member 54 applies equally to third wishbone member 66. Rolled end 104 defines an inner diameter 160 sized to correspond to a diameter of first pin 150. Rolled end 104 also includes an axis 162 which is spaced from an axis 164 of an aperture 166 created on extension plate portion 112 by a spacing dimension “L”. First stiffening wall 106 can be divisible into first and second portions 106, 106′ which are fixed together for example by welding. Similarly, second stiffening wall 108 can be divisible into first and second portions 108, 108′ which are fixed together for example by welding. The shape of first and second stiffening walls 106, 108 can vary from that shown to increase or decrease the amount of bending stiffness required.

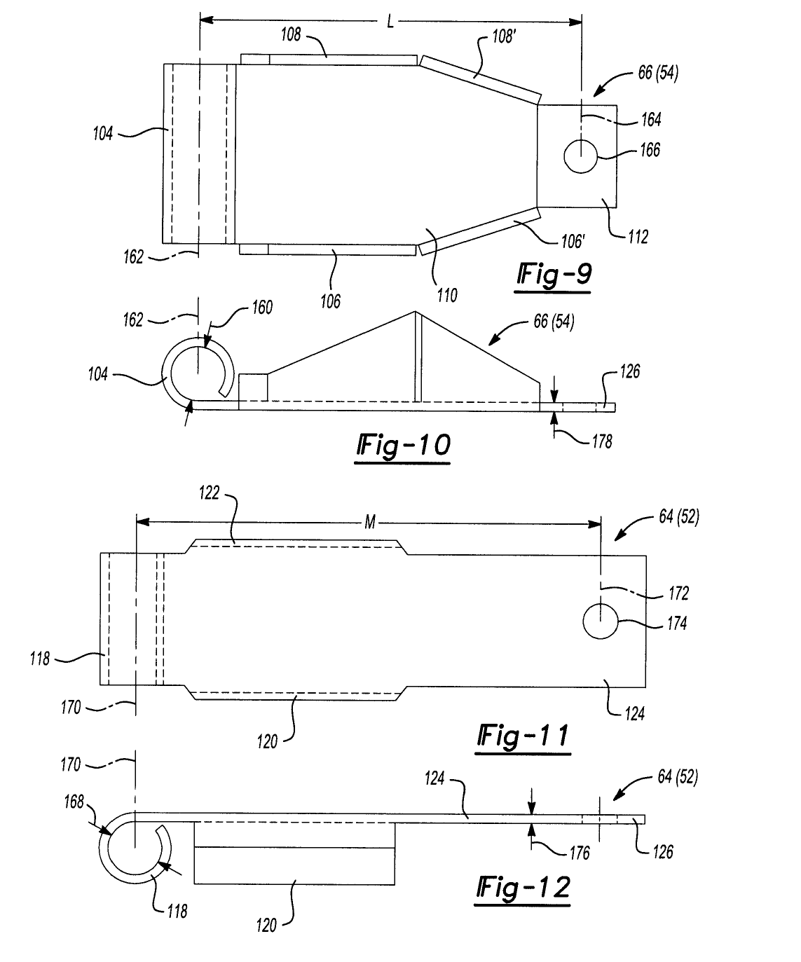

Referring now in general to FIGS. 11 and 12, each of the second and fourth wishbone members 52, 64 are substantially identical, therefore the following discussion of second wishbone member 52 applies equally to fourth wishbone member 64. Rolled end 118 defines an inner diameter 168 sized to correspond to a diameter of second pin 153. Rolled end 118 also includes an axis 170 which is spaced from an axis 172 of an aperture 174 created on extension plate portion 126 by a spacing dimension “M”. In several embodiments, spacing dimension “M” is greater than spacing dimension “L” so that second and fourth wishbone members 52, 64 are longer than first and third wishbone members 54, 66. Also, a material thickness “176” of the second and fourth wishbone members 52, 64 can be greater than a material thickness “178” of the first and third wishbone members 54, 66 to increase the stiffness of second and fourth wishbone members 52, 64 due to the greater length “M”.

The description herein is merely exemplary in nature and, thus, variations that do not depart from the gist of that which is described are intended to be within the scope of the present disclosure. Such variations are not to be regarded as a departure from the spirit and scope of the present disclosure.

What is claimed is:

1. A suspension system for a golf car, comprising:
a vehicle frame;
a channel member connected to the frame;
first and second wishbone members rotatably connected to the channel member and operable to rotatably support a wheel hub assembly; and
a shock absorber assembly freely extending through the first wishbone member and connected to the second wishbone member.

2. The suspension system of claim 1, further comprising a connecting element extending from the second wishbone member operable to receive a first connecting end of the shock absorber assembly.

3. The suspension system of claim 2, further comprising a structural member connected to a first end of the channel member and extending distally therefrom, the structural member adapted to receive a second connecting end of the shock absorber assembly.

4. The suspension system of claim 3, wherein the first and second wishbone members, the channel member, and the shock absorber assembly define an assembly connectable to the vehicle frame at each of a first frame connecting position and a second frame connecting position, the connecting positions operable to vary a height of the suspension system.

5. The suspension system of claim 4, further comprising a first pin rotatably connecting the first wishbone member to the channel member proximate the first end of the channel member, and a second pin rotatably connecting the second wishbone member proximate a second end of the channel member.

6. The suspension system of claim 5, further comprising:
a substantially circular-formed first end of each of the first and second wishbone members operable to receive one of the first and second pins; and
a resilient material bushing disposed within the circular-formed first end of each of the first and second wishbone members having a through aperture operable to receive one of the first and second pins.

7. The suspension system of claim 6, wherein each of the first and second wishbone members further comprise a substantially flat plate portion defining a second end, the second end operable to receive a ball joint connector of the wheel hub assembly.

8. The suspension system of claim 1, wherein a length of the second wishbone member is greater than a length of the first wishbone member.

9. The suspension system of claim 1, wherein a material thickness of the second wishbone member is greater than a material thickness of the first wishbone member.

10. A suspension system for a golf car, comprising:
a vehicle frame having at least first and second longitudinally configured frame elements;
first and second channel members, the first channel member connected to the first frame element and the second channel member connected to the second frame element;
first and second wishbone assemblies, the first wishbone assembly coupled to the first channel member and the second wishbone assembly coupled to the second channel member, each of the first and second wishbone assemblies including:
a first wishbone member rotatably connected to a first end of one of the first and second channel members;
a second wishbone member rotatably connected to a second end opposite to the first end; and
a wheel hub assembly rotatably connected to both the first and second wishbone members.

11. The suspension system of claim 10, further comprising a shock absorber assembly freely extending through the first wishbone member and connected to the second wishbone member of each of the first and second wishbone assemblies.

12. The suspension system of claim 11, wherein each of the first and second wishbone assemblies further comprise a clevis connected to the second wishbone member operable to receive a first connecting end of the shock absorber assembly.

13. The suspension system of claim 12, further comprising:
a first structural member connected to and distally extending away from a first end of the first channel member; and
a second structural member connected to and distally extending away from a first end of the second channel member;
wherein the first structural member is adapted to receive a second connecting end of the shock absorber assembly of the first wishbone assembly, and the second structural member is adapted to receive a second connecting end of the shock absorber assembly of the second wishbone assembly.

14. The suspension system of claim 13, further comprising a channel member connected at opposed ends to the first and second structural members.

15. The suspension system of claim 10, wherein each of the first and second channel members comprise a predetermined pattern of apertures, the first and second channel members being connectable to the respective first and second frame elements using at least one fastener inserted through a selected aperture of the predetermined pattern of apertures to define at least a first suspension system height and a second suspension system height.

16. The suspension system of claim 10, wherein a length of the second wishbone member is greater than a length of the first wishbone member.

17. The suspension system of claim 10, wherein a material thickness of the second wishbone member is greater than a material thickness of the first wishbone member.

18. A golf car, comprising:
a frame;
a front suspension system adjustably connected to the frame having a first side and a second side and operable to rotatably support a first steerable wheel from the first side and a second steerable wheel from the second side;
a first double wishbone assembly connected to the first side of the front suspension system; and
a second double wishbone assembly connected to the second side of the front suspension system.

19. The golf car of claim 18, wherein each of the first and second double wishbone assemblies further comprises:
a substantially U-shaped channel connectable to the frame;
a first wishbone member rotatably connected to an upper end of the U-shaped channel; and
a second wishbone member rotatably connected to a lower end of the U-shaped channel.

20. The golf car of claim 19, wherein each of the first and second double wishbone assemblies further comprises a wheel hub assembly rotatably connected to both the first and second wishbone members.

21. The golf car of claim 20, further comprising a shock absorber assembly freely extending through the first wishbone member and connected to the second wishbone member for each of the first and second double wishbone assemblies.

22. The golf car of claim 21, wherein a plane defined by a rotational axis any one of the first and second steerable wheels is substantially parallel with a ground surface during an arc of rotation of the associated first or second wishbone assembly to maximize a wheel tread contact with the ground surface.

23. The golf car of claim 19, wherein the U-shaped channel further comprises a plurality of mounting apertures through which at least one fastener is insertable to engage the frame,

24. The golf car of claim 23, wherein the plurality of mounting apertures further comprises first apertures and second apertures, the first apertures separated from the second apertures by a distance defining an adjustable height of the front suspension system.

25. The golf car of claim 19, wherein a length of the second wishbone member is greater than a length of the first wishbone member.

26. A method for using a double wishbone suspension system in a golf car, the golf car having a frame, the suspension system including an upper and lower wishbone member connected to an adjustably located structural member, a shock absorber and a wheel hub assembly, the method comprising:
rotatably coupling both the upper and lower wishbone members to the structural member;
connecting the shock absorber to both the lower wishbone member and an arm extending from the structural member; and
rotatably connecting distal ends of both the upper and lower wishbone members to the wheel hub assembly.

27. The method of claim 26, further comprising creating a plurality of apertures in the structural member.

28. The method of claim 27, further comprising spacing first ones of the plurality of apertures from second ones of the plurality of apertures.

29. The method of claim 28, further comprising connecting the structural member to the frame using the first ones of the plurality of apertures to create a first suspension system height.

30. The method of claim 28, further comprising connecting the structural member to the frame using the second ones of the plurality of apertures to create a second suspension system height.

31. The method of claim 26, further comprising extending the shock absorber freely through the upper wishbone member.

32. The method of claim 26, further comprising creating the lower wishbone member longer than the upper wishbone member.

33. The method of claim 26, further comprising positioning a flange between the wheel hub assembly and both the upper and lower wishbone members.
